(19) United States
(12) Patent Application Publication
(10) Pub. No.: US 2015/0309066 A1
(43) Pub. Date: Oct. 29, 2015

(54) Underspeed detection device, associated ventilation system and vehicle

(71) Applicant: TECHNOFAN, Blagnac (FR)

(72) Inventors: Pascal TOUTAIN, Blagnac (FR); Xavier LONGERE, Blagnac (FR); Samuel BONNARD, La Salvetat Saint Gilles (FR)

(21) Appl. No.: 14/609,556

(22) Filed: Jan. 30, 2015

(30) Foreign Application Priority Data
Jan. 30, 2014 (FR) 14 50732

(51) Int. Cl. G01P 3/60; G01P 3/48; B64D 13/08

(52) U.S. Cl. CPC G01P 3/60; B64D 13/08; G01P 3/4802

(57) ABSTRACT

The invention relates to an underspeed detection device (2) for a motor (4) comprising a stator and a rotor movable relative to the stator, the detection device (2) comprising detection means (12) able to generate an electric rotation signal (iᵣ) representative of the speed of rotation of the rotor, and electronic analysis means (20) able to analyze the rotation signal (iᵣ) to detect an underspeed situation, characterized in that the detection device (2) further comprises conversion means (18) able to convert part (iₚ) of the electric rotation signal (iᵣ) into a power supply current (iₐₗ) for the analysis means (20), and means for applying the power supply current (iₐₗ) to the analysis means (20) for their electric power supply.

The present invention relates to an underspeed detection device of an engine comprising a stator and a rotor movable relative to the stator, the detection device comprising detection means able to generate an electric rotation signal representative of the speed of rotation of the rotor, and electronic analysis means able to analyze the rotation signal to detect an underspeed situation.

The invention applies to controlling the speed of rotation of the rotor of a motor, for example a motor of a ventilation system onboard a vehicle.

Such ventilation systems are generally dedicated to functions such as cooling, gas removal or ventilation for passengers of the vehicle.

In general, a ventilation system must provide a gas flow rate higher than a predetermined minimum flow rate. Consequently, the speed of rotation of the rotor of the motor of the ventilation system must be higher than a predetermined minimum speed.

The invention in particular applies to underspeed detection of the motor.

Within the meaning of the present invention, “underspeed” refers to a situation in which the speed of rotation of the rotor of the motor is lower than the predetermined minimum speed.

It is known to use underspeed detection devices. These devices generally comprise a phonic wheel, secured to the rotor of the motor, and a Hall effect sensor, secured to its stator and positioned across from the phonic wheel. The phonic wheel comprises a magnetic element able to emit a magnetic field, for example a permanent magnet. The detector is able to detect the passage of the magnetic element and generate an electric rotation signal representative of the speed of rotation of the rotor. These underspeed detection devices also comprise electronic analysis means for analyzing the rotational signal and detecting the underspeed.

Traditionally, the power supply current for these detection devices comes from the vehicle's electrical wiring system, which is generally a three-phase, high-voltage (115 VAC or 230 VAC) system with a variable frequency and voltage. The electrical characteristics of this type of three-phase network, such as the imbalance of the phases and voltages, overvoltages and voltage interruptions, imply using complex and highly robust electronic devices to supply DC current to the analysis means. This involves using a transformer, to provide electrical insulation, and electric protection and filtering devices, to supply the analysis means with DC current from the three-phase electrical wiring system of the vehicle. The presence of a transformer and electrical protection and filtering devices reduces the possibilities for miniaturization and weight reduction of the detection device. Yet volume and mass are critical parameters of onboard systems.

One aim of the invention is to propose an underspeed detection device of a motor that is more compact, lighter and independent of the characteristics of the three-phase electrical wiring system of the vehicle, which contributes to increasing the reliability of the device.

To that end, the invention relates to an underspeed detection device for a motor of the aforementioned type, further comprising conversion means able to convert part of the electric rotation signal into a power supply current of the analysis means, and means for applying the power supply current to the analysis means to supply them with electricity.

In fact, the power supply current of the analysis means coming from the rotation current, the presence of a transformer is superfluous and the device is therefore more compact, lighter, more reliable and more robust.

According to specific embodiments, the invention has one or more of the following features, considered alone or according to any technically possible combination(s):
the conversion means are able to convert the part of the electric rotational signal into a substantially DC power supply current;
the analysis means are able to be powered only by the power supply current from the conversion means;
the detection means comprise a detector comprising at least one turn that is stationary relative to the stator and a magnetic element that is rotatable with the rotor and at least partially across from the or each turn;
the magnetic element is a permanent magnet;
the detector comprises a plurality of turns electrically connected to form a coil;
the coil is made in a multilayer printed circuit.

Furthermore, the invention relates to a ventilation system comprising a motor and an underspeed detection device for the motor, as defined above.

Furthermore, the invention relates to a vehicle comprising a ventilation system as defined above.

According to another advantageous aspect of the invention, the vehicle is an aircraft.

The invention will be better understood using the following description, provided solely as a non-limiting example and done in reference to the appended drawings, in which:

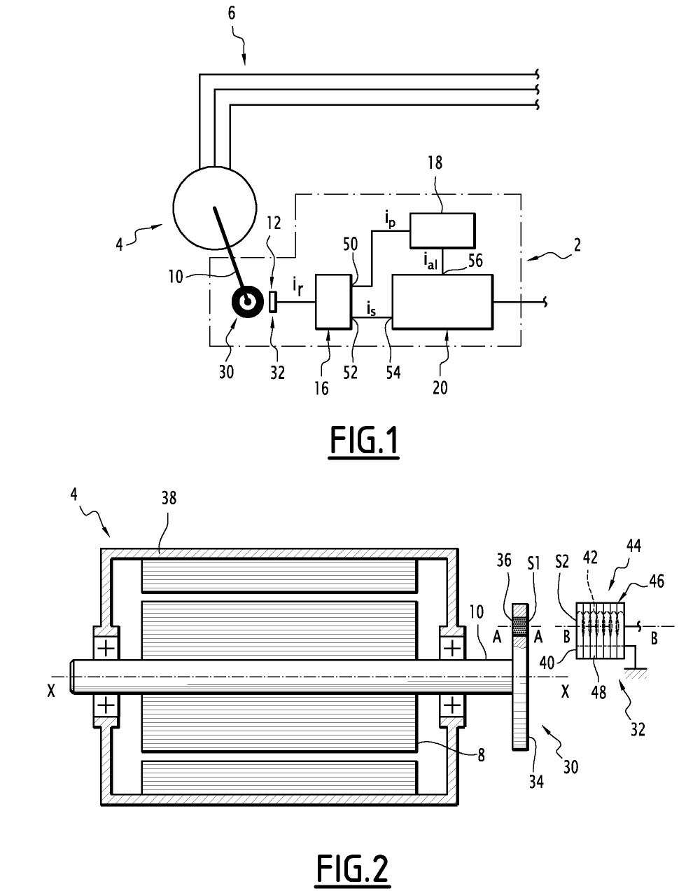

FIG. 1 is a detail of a diagrammatic illustration of a ventilation system comprising a detection device according to the invention; and

FIG. 2 is a longitudinal cross-sectional view of the motor of the ventilation system of FIG. 1.

An underspeed detection device 2 according to the invention is shown in FIG. 1. The underspeed detection device 2 is able to detect the underspeed of a motor 4 of the ventilation system, for example a ventilation system for an aircraft.

The underspeed detection system 2 is also able to send an alert signal to control means (not shown) of the motor if an underspeed situation is detected.

The motor 4 is an electric motor, for example an asynchronous motor. The motor 4 is powered by the aircraft electrical wiring system 6, for example a three-phase electrical wiring system.

The motor 4 comprises a rotor 8, shown in FIG. 2, to which a shaft 10 is secured. The shaft 10 extends along a longitudinal axis X-X and can be rotated around a longitudinal axis X-X by the rotor 8.

As illustrated by FIG. 1, the underspeed detection device 2 comprises means 12 for detecting the speed of rotation of the rotor 8, means 16 for sampling part of an electrical current, means 18 for converting an AC current into an AC or DC current, and electronic means 20 for analyzing the spectrum of an AC current.

The detection means 12 are able to provide an AC electric rotation current iᵣ. The central frequency of the rotation current iᵣ is representative of the speed of rotation of the rotor 8. The analysis means 20 are able to compare the central frequency of the electric rotation current iᵣ to a predetermined reference frequency f₀.

As shown in FIG. 2, the detection means 12 comprise a phonic wheel 30 and a detector 32.

The phonic wheel 30 is secured to the rotor 8 of the motor 4 and can be rotated around the axis X-X by the rotor 8.

The phonic wheel 30 comprises a front face 34 and an off-centered magnetic element 36.

The magnetic element 36 can emit a magnetic field along an emission axis A-A parallel to the longitudinal axis X-X. Preferable, the magnetic element 36 is a permanent magnet.

The front face 34 delimits a surface S1 of the magnetic element 36.

The detector 32 is able to detect the magnetic field emitted by the magnetic element 36. The detector 32 is able to generate the rotation current iᵣ.

The detector 32 is stationary relative to the stator 38 of the motor 4.

The detector 32 comprises a front face 40 and a plurality of turns 42 with a shared magnetic axis B-B parallel to the longitudinal axis X-X.

The turns 42 are electrically connected to form a coil 44 extending along the axis B-B.

The terminals of the coil 44 form the output of the detection means 12.

One current turn 42 of the coil 44 delimits a surface S2 of the front face 40 of the detector 32.

The detector 32 is for example made up of a multilayer printed circuit 46 comprising a plurality of superimposed layers 48. Each layer 48 of the printed circuit 46 is thus etched to define a current turn 42. The turns are electrically connected, for example by vias, to form the coil 44.

The detector 32 is positioned across from the phonic wheel 30, at a distance from the phonic wheel 30, the surface S1 being parallel to the surface S2. The detector 32 is positioned such that there is an angle of rotation of the phonic wheel 30 so that the surfaces S1 and S2 are across from each other, the axes A-A of the magnetic element 36 and B-B of the coil 44 being combined.

The sampling means 16 comprise an input connected to the output of the detection means 12 and two outputs 50, 52.

The sampling means 16 can sample part of the rotation current iᵣ captured at their input and coming from the detection means 12 to apply it in the form of a sampled current iₚ at one of their outputs iₚ, called power supply output 50.

Furthermore, the sampling means 16 are able to apply at another of their outputs, called signal output 52, another part of the rotation current coming from the detection means 12, in the form of a signal current iₛ with a frequency substantially equal to the frequency of the rotation current iᵣ.

The sampling means 16 are for example a rectifier bridge, a charge pump or a current-voltage converter.

The conversion means 18 are connected to the power supply output 50 of the sampling means 16 and are able to convert the sampled AC current iₚ into electric current iₐₗ designed to power the analysis means 20. The current i ₐₗ is for example direct.

The conversion means 18 are for example a linear voltage regulating stage.

The analysis means 20 comprise two inputs 54 and 56 and one output connected to the control means of the motor 4.

The analysis means 20 are able to detect at their input 54, called signal input, the signal current iₛ coming from the sampling means 16.

The analysis means 20 are also able to detect at their input 56, called power supply input, the power supply current iₐₗ from the conversion means 18.

The analysis means 20 are able to be powered solely by the power supply current iₐₗ coming from the conversion means 18.

The analysis means 20 are able to analyze the signal current iₛ, coming from the signal output 52 of the sampling means 16, to determine the central frequency thereof.

The analysis means 20 are also able to compare the central frequency of the signal current iₛ to the predetermined reference frequency f₀.

During operation, the motor 4 is connected to the electrical wiring system 6 to be powered. The stator 8 rotates the phonic wheel 30 around the axis X-X by means of the shaft 10, for example at a speed of 20,000 RPM.

Over time, the surface S1 once again finds itself again from the surface S2 at a frequency dependent on the speed of rotation of the rotor 8 of the motor 4. The coil 44 then has a magnetic field varying over time at a frequency depending on the speed of rotation of the rotor 8 of the motor 4. The rotation current iᵣ is generated by induction in the coil 44. The frequency of the rotation current iᵣ depends on the speed of rotation of the rotor 8 of the motor 4.

The electric rotation current iᵣ is applied at the input of the sampling means 16.

Part of the rotation current iᵣ is sampled by the sampling means 16 and forms the sampled current iₚ available at the power supply output 50 of the sampling means 16.

The conversion means 18 convert the sampled current iₚ into the power supply current iₐₗ of the analysis means 20.

The power supply current iₐₗ is applied by the output of the conversion means 18 to the power supply input 56 of the analysis means 20.

The other part of the electric rotation current iᵣ forms the signal current iₛ to be analyzed, available at the signal output 52 of the sampling means 16.

The frequency of the signal current iₛ is substantially equal to the frequency of the rotation current i.

The current iₛ to be analyzed is applied by the signal output 52 of the sampling means 16 to the signal input 54 of the analysis means 20.

The electronic analysis means 20, powered by the power supply current iₐₗ, analyze the signal current iₛ and calculate its central frequency, representative of the speed of rotation of the rotor 8 of the motor 4.

If the calculated central frequency is below the predetermined reference frequency f₀, the analysis means 20 detect an underspeed situation and send an alert signal to the control means (not shown) of the motor 4.

Alternatively, the emission axis A-A of the magnetic element 36 is not parallel to the longitudinal axis X-X.

For example, the direction of the magnetic field is perpendicular to the longitudinal axis X-X. The detector 32 is arranged so that there is an angle of rotation of the phonic wheel 30 such that the axes A-A of the magnetic element 36 and B-B of the coil 44 are combined, for example by positioning the detector 32 such that the axis B-B is perpendicular to the longitudinal axis X-X.

1. A ventilation system comprising a motor and an underspeed detection device of an engine comprising a stator and a rotor movable relative to the stator, the detection device comprising detection means able to generate an electric rotation signal representative of the speed of rotation of the rotor, and electronic analysis means able to analyze the rotation signal to detect an underspeed situation,
characterized in that the detection device further comprises conversion means able to convert part of the electric rotation signal into a power supply current of the analysis means, and means for applying the power supply current to the analysis means to supply them with electricity.

2. The system according to claim 1, characterized in that the conversion means are able to convert the part of the electric rotational signal into a substantially DC power supply current.

3. The system according to claim 1, characterized in that the analysis means are able to be powered solely by the power supply current coming from the conversion means.

4. The system according to claim 1, characterized in that the detection means comprise a detector comprising at least one turn that is stationary relative to the stator and a magnetic element that is rotatable with the rotor and at least partially across from the or each turn.

5. The system according to claim 4, characterized in that the magnetic element is a permanent magnet.

6. The system according to claim 4, characterized in that the detector comprises a plurality of turns electrically connected to form a coil.

7. The system according to claim 6, characterized in that the magnetic element is made from a multilayer printed circuit.

8. A vehicle comprising a ventilation system according to claim 1.

9. The vehicle according to claim 8, characterized in that it is an aircraft.
